(19) United States
(12) Patent Application Publication
(10) Pub. No.: US 2005/0075100 A1
(43) Pub. Date: Apr. 7, 2005

(54) Method and system for accessing a drawing of lots

(76) Inventor: Sergio Porcellini, Ivrea (Torino) (IT)

Correspondence Address: SUGHRUE MION, PLLC, 2100 PENNSYLVANIA AVENUE, N.W., SUITE 800, WASHINGTON, DC, 20037, US

(21) Appl. No.: 10/879,731

(22) Filed: Jun. 30, 2004

(30) Foreign Application Priority Data
Sep. 12, 2003 (IT) TO2003A000696

(51) Int. Cl. H04Q 7/20

(52) U.S. Cl. 455/414.1

(57) ABSTRACT

A method for accessing a drawing of lots of the type whereby one or more accesses (S) to said drawing of lots are issued as a result of a request (R) for a service, comprising the operations of delivering said service (I) through one or more telecommunications networks (12, 14, 15, 17) to a user terminal (16, 18) and associating the issuance of one or more accesses (S) to the lot drawing to the delivery of the service (I).

The present invention relates to a method for accessing a drawing of lots of the type entailing the emission of one or more accesses to said drawing of lots according to the request of a service.

To allow access to the drawing of lots, lotteries and drawings of prizes, multiple systems are known, entailing, in the simplest form, the issuance of numbered tickets for the drawing of prizes, which tickets are purchased by the participants.

Also known is the connection of lot drawing and games with prizes to information distribution services. For example, the distribution of bingo or tombola cards together with the sale of daily papers is known. The game is thereby made readily accessible to many persons, exploiting the wide circulation of the daily paper, and at the same time, the purchase of said paper is encouraged.

It is more difficult to allow access to similar drawings of lots, lotteries, and drawings of prizes in connection with the distribution of services, in particular information services, conveyed through telecommunication networks.

The object of the present invention is to overcome all the aforesaid drawbacks.

In view of achieving said object, the invention relates to a method for accessing a drawing of lots having the characteristics set out at the start and further characterised in that it delivers said service through one or more telecommunications networks to a user terminal and it associates the issuance of one or more accesses to the lot drawing to the delivery of the service.

In the preferred embodiment, said telecommunications network comprises a mobile telecommunications network and said user terminal is a mobile user terminal, the request and the delivery of said service being operated through an SMS (Short Message System) messaging system.

Naturally, the invention also relates to the system for accessing a lot drawing which implements the method described above, as well as the corresponding computer product directly loadable into the memory of a digital computer such as a processor and comprising portions of software code to implement the method according to the invention when the product is executed on a computer.

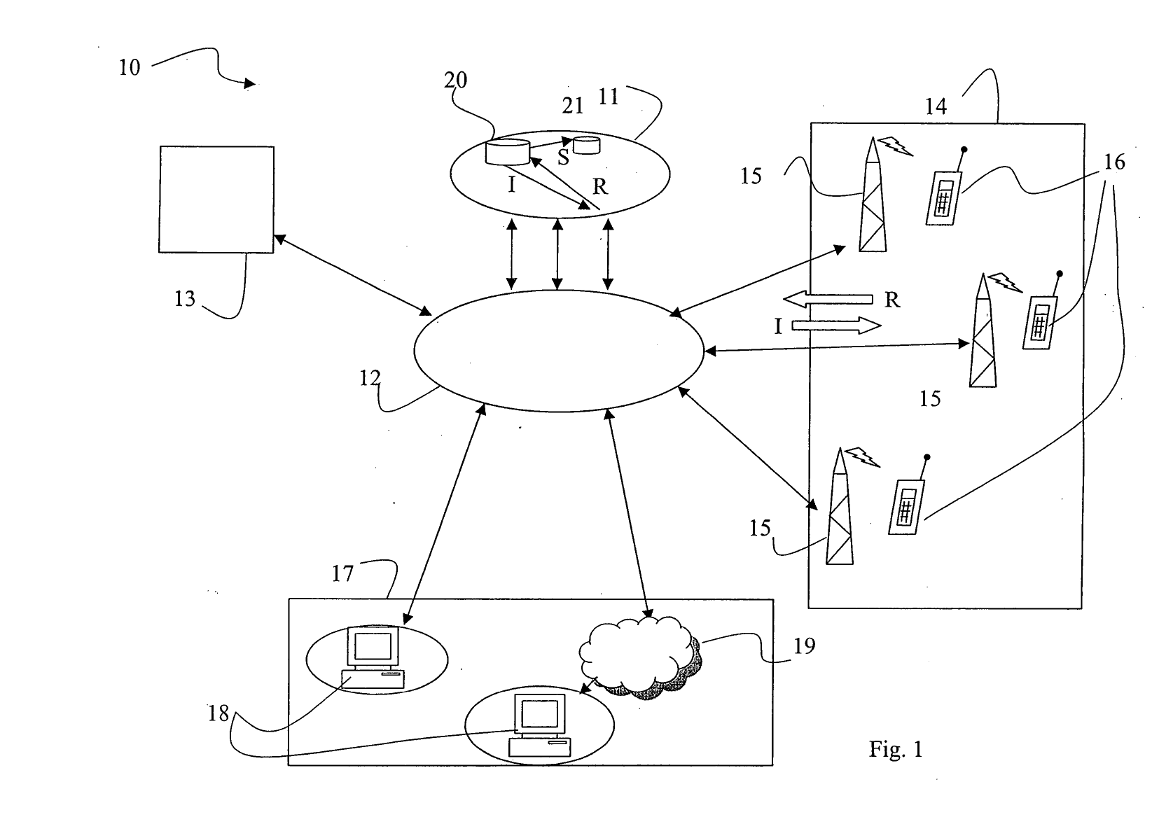

Additional characteristics and advantages of the present invention shall become readily apparent from the description that follows with reference to the accompanying drawings, provided purely by way of explanatory and non limiting example, in which FIG. 1 is a schematic view of a system implementing the method according to the invention,

With reference to FIG. 1, the number 10 globally designates a system for accessing a drawing of lots implementing the method according to the invention.

Said system for accessing a drawing of lots 10 comprises a plurality of application processors 11, which are associated in information exchange relationship with an aggregation network 12. For example, the application processors 11 can be server computers, hence provided with appropriate microprocessors, memory means and peripherals, connected to a WAN (Wide Area Network) access network which embodies the aggregation network 12. To this aggregation network 12, relating to the set of application processors 11, is associated in information exchange relationship a plurality of networks of mobile clients 14, a plurality of fixed telephony networks 17 and a plurality of credit institutions 13. The aggregation; network 12 provides them with the connectivity and interconnection to the application processes 11, also known in themselves.

The plurality of networks of mobile clients 14 comprises a plurality of mobile telephony networks 15, each of said mobile telephony networks 15 exchanging information in known fashion with mobile user terminals 16, in particular cellular telephones.

The set of fixed telephony networks 17 comprises fixed user terminals 18, such as personal computers, which can be connected for information exchange with the aggregation network 12, either directly or through the Internet 19.

The application processors 11 are able to manage service delivery applications, e.g. the delivery of instantaneous information such as stock market indexes, horoscopes, weather forecasts or sporting results, to the mobile user terminals 16 and the fixed user terminals 18. Services of this kind and the procedures for providing them both over mobile client networks 14 and over fixed telephony networks 17 are known and therefore shall not be described in detail herein, but clearly they may provide for the existence of appropriate databases, designated by the reference 20 in FIG. 1, contained in the memory means of the application processors 11, or residing on other computers to said connected application processors 11. Said databases 20 contain the instantaneous information I relating to the service required by the user. In the same way, the application processors 11 are able to record identifying information about the mobile 16 or fixed 18 user terminal requesting the delivery of the service such as access to the drawing of the lots S in an appropriate list 21 for the drawing of the lots and possibly to carry out said drawing among all the accesses S present in the list 21, for example by applying a random drawing function to said list for the lot drawing 21.

According to the method for accessing a proposed lot drawing, in a preferred embodiment, a user sends a service request R through an SMS (Short Message System) message through the mobile user terminal 16. Said service may be, by way of example, the delivery of an instantaneous information I of a stock market index.

Said service request R is transmitted through the mobile telephony network 15, which is able to communicate with the aggregation network 12, so that lastly the service request R reaches the application processor 11 pertaining to that specific service.

The application processor 11 delivers the instantaneous information I towards the mobile terminal 16, whilst charging for the service, in particular, exploiting the connection through the aggregation network 12 with the credit institutions 13 in the case, for instance, that the service is of the type with credit card debiting.

The application processor 11 then signs up the user who requested the information to a drawing of a prize, forwarding the identity of the user terminal in the form of access S or electronic ticket stored in the drawing list 21.

According to a preferred version of the invention, the drawing procedure is organised according to time bands. In particular, the drawing can be subdivided into:
hourly prize, to be drawn among all the players who forward a request for information R during the last hour;
daily prize, to be drawn among all the players who forward a request for information R during the last day;
weekly prize, to be drawn among all the players who forward a request for information R during the last week;
monthly prize, to be drawn among all the players who forward a request for information R during the last month;
yearly prize, to be drawn among all the players who forward a request for information R during the last year;

The amount of the prize to be paid in case of win can be established as a percentage of the revenues of the service in the corresponding time band.

The application processor 11 can send to the mobile terminal 16 or fixed terminal 18 a message that represents or attests the access S to the drawing, i.e. the electronic ticket, and it can also notify a win through the same telecommunication means that are available to forward the instantaneous information service and to pay out said win exploiting the connection through the aggregation network 12 with the credit institutions 13.

The solution described above enables to achieve considerable advantages with respect to prior art solutions.

The method and the corresponding system for accessing a drawing of lots, described above, advantageously allow to combine drawings and prize games to the transmission of information to user terminals through telecommunication networks, resulting in a system that is simple and clear for the user who is already familiar with the use of said terminals, in particular with the operations of sending and receiving SMS messages via cellular telephone, currently highly popular.

Moreover, advantageously the proposed method for accessing a drawing of lots allows to connect, in a manner that is simple and understandable for the user the amount of the prize and the probability of winning to the number of service requests and/or to the frequency of said requests.

Lastly, advantageously the method for accessing a drawing of lots also constitutes an incentive to request information services transmitted to user terminals via telecommunication networks.

Naturally, without altering the principle of the invention, the construction details and the embodiments may vary widely from what is described and illustrated purely by way of example herein, without thereby departing from the scope of the present invention.

In particular, the mobile telephony networks may be GPS, GPRS or UMTS networks, without protocol or frequency limitations.

In the same way, the connection over a fixed network may take place by direct connection of the user terminals via modem, radio frequency or optical fibre, and the connection may take place, exploiting the same variety of physical support means, through an Internet Protocol network.

The involved services may for instance be information services for mobile telephony via WAP (Wireless Application Protocol), and they may also be information services for fixed terminals, such as personal computer, which receive information via electronic mail or via an Internet browser, and in general the involved services can be all those able to be associated to system for delivering services through telecommunications networks, of the type whereby a service request is sent through a user terminal, connected to said telecommunications networks, to a central unit for the delivery of the service, said central unit for the delivery of the service, upon receiving said service request, delivering the service to the user terminal.

1. A method for accessing a drawing of lots of the wherein one or more accesses to said drawing of lots are issued as a result of a request for a service, comprising the operations of delivering said service through one or more telecommunications networks to a user terminal and associating the issuance of one or more accesses to the lot drawing to the delivery of the service.

2. A method as claimed in claim 1, wherein the operation of delivering said service through one or more telecommunications networks comprises the delivery over a mobile telecommunications network and to mobile user terminal.

3. A method as claimed in claim 2, wherein the request and the deli very of said service are operated through an SMS (Short Message System) messaging system.

4. A method as claimed in claim 1, wherein the operation of delivering said service through one or more telecommunications networks comprises the delivery over a fixed telecommunications network and said user terminal fixed user terminal, particular personal computer.

5. A method as claimed in claims 2, comprising, included in said one or more telecommunications networks, an aggregation network for the exchange of information with application programs which deliver said service.

6. A method as claimed in claims 2 comprising the operation of exchanging information between said application programs and credit institutions through said one or more telecommunications networks to perform the operations of charging the service and/or prize-giving for the drawing.

7. A method as claimed in claim 1, wherein said delivered service instantaneous information service.

8. A system for accessing a drawing of lots, comprising processing means to execute application programs able to deliver services and to record the access to the lot drawing, and one or more telecommunications network to exchange information with user terminals.

9. A system as claimed in claim 8, wherein said processing means comprise a first database to store information about the service to be delivered and a second database record the access the lot drawing.

10. A system as claimed in claim 9, wherein said one or more telecommunications networks comprises a mobile telecommunications network and said user terminal is a mobile user terminal.

11. A system as claimed in claim 9, wherein said one or more telecommunications networks comprises a mobile telecommunications network and said user terminal fixed user terminal, particular personal computer.

12. A system as claimed in claim 10, wherein said one or more telecommunications networks comprises Internet Protocol network.

13. A method for providing incentives to accessing system for delivering services through telecommunications networks, comprising the step of sending a service request through a user terminal, connected to telecommunications networks, to central service delivery unit, said central service delivery unit, upon receiving said service request, delivering the service to user terminal, each service request receiving one or more accesses to a lot drawing.
